(19) United States
(12) Patent Application Publication
(10) Pub. No.: US 2009/0027697 A1
(43) Pub. Date: Jan. 29, 2009

(54) System and Method for Conserving Receipt Paper on a Transaction Receipt

(76) Inventors: Kyle Turner, Lake Forest, IL (US); Michael D. Gera, Ithaca, NY (US); Barry J. Shaw, Ithaca, NY (US); Robert Delaney, Ithaca, NY (US)

Correspondence Address: BOND, SCHOENECK & KING, PLLC, ONE LINCOLN CENTER, SYRACUSE, NY, 13202-1355, US

(21) Appl. No.: 12/036,682

(22) Filed: Feb. 25, 2008

Related U.S. Application Data
(60) Provisional application No. 60/891,377, filed on Feb. 23, 2007.

(51) Int. Cl. G06F 3/12

(52) U.S. Cl. 358/1.1

(57) ABSTRACT

The present invention relates generally to a system and method for reducing the amount of paper required to print a standard transaction receipt, and, more particularly, to a system and method for automatically formatting receipt data sent to a receipt printer such that body text can be placed side by side rather than in a vertical row.

### RELATED APPLICATION

The present application claims priority to U.S. provisional application Ser. No. 60/891,377, filed Feb. 23, 2007, the entirety of which is hereby incorporated by reference.

### BACKGROUND OF THE INVENTION

1. Field of Invention

The present invention relates generally to a system and method for reducing the amount of paper required to print a standard transaction receipt, and, more particularly, to a system and method for automatically formatting receipt data sent to a receipt printer such that body text can be placed side by side rather than in a vertical row.

2. Description of Prior Art

With an increased focus on the impact of CO₂ emissions on Global Warming there has been increased pressure placed upon manufacturers of all goods and services to take into account the environmental impact that goods or services have during the manufacturing, shipping, operation and disposal of said goods or services.

A product of concern regarding its environmental impact is paper. Many industries focus on the conservation and recycling of paper. A standard transaction receipt has become part of that focus. The standard transaction receipt is typically comprised of three sections: header information, body or item text, closing information. The most common implementation of receipt printing has the body or item text printed in a vertical column with no two items sharing a row. The net result of this format is a large degree of empty space in the body of the receipt. In multi-item applications, such as grocery stores, this portion of the receipt can account for 90% or more of the total receipt length.

In response to this environmental impact pressure, members of the printer product industry have designed and developed products that result in a net paper savings in the area of transaction receipts. For example, efforts have been undertaken to design a series of printer product offerings that allow for the printing of a thermal receipt on both the front and back of the receipt media or paper. This printer product requires thermal receipt paper which has a chemical coating on its front and back. This printer product can be placed on a standard point of sale installation. Software resident in the printer's memory reviews the data streams being sent to the printer, applies a set of decision criteria to determine where to segment the data, and prints a portion of the receipt data on the front of the receipt as well as a portion of the receipt data on the back of the receipt. While the net paper savings could conceptually be 50%, the actual savings has been proven in lab trials to be between 30% and 45%, depending on total receipt length.

While the chemical coating required by the above referenced printer product is common to all thermal receipt paper, the coating is needed on both sides where historically it has only been required on one side. As a result, increased processing time and materials are required to manufacture the two sided thermal paper. This increased time and materials currently results in increased consumer costs of 50 to 60% above that of standard one sided media.

In addition to the increased media costs, the above referenced printer product requires a special printer be used. This special printer utilizes two opposed thermal printing heads that can be used to print on both sides of the special two sided media. Thermal print heads and the supporting circuitry to drive them can account for as much as 10% of the total material costs in the manufacture of a thermal receipt printer. As a direct result, this printer product is often presented to the market with a premium attached.

Current implementation of this printer product requires a threading operation to get the media in the correct path in order for both heads to contact the media. This mode of paper loading is slower than the “drop in loading” method used on many standard one sided thermal receipt printers.

Moreover, operation of the these two sided thermal printers requires increased power to print at their highest published speeds. This is due to the fact that this printer product must drive two thermal print heads consecutively, compared to a standard thermal printer that only requires operation of a single head. A result of this increased power demand is that the two sided printer is incapable of running at full speed when power for the printer is derived from a powered USB connection to a Point of Sale terminal. This is due to the fact that the power footprint provided by most of the terminals currently available on the market cannot support the draw required to drive both thermal heads at full speed.

Additionally, the above referenced printer product is incompatible with the latest forms of receipt media (including thinner, lighter weight thermal papers) due to show through of the text printed on the back interfering with the text on the front face of the receipt.

Further issues with this printer product arise in grocery store applications that typically subsidize receipt paper costs by working with third party advertising agencies to place pre-printed promotions on the back of the receipt media. This printer product makes this practice difficult, if not impossible, because it requires that the receipt now be printed on the back to gain the environmental savings.

Therefore, it would be useful and desirable to have a system and method to overcome the above-mentioned disadvantages of the prior art.

### SUMMARY OF TH INVENTION

In accordance with an embodiment of the present invention, a system and method for reducing the amount of paper required to print a standard transaction receipt, and, more particularly, a system and method for automatically formatting receipt data sent to a receipt printer such that body text can be placed side by side rather than in a vertical row, is provided.

In accordance with an embodiment of the present invention, a new and more efficient format for receipt data (alphanumeric characters) in provided to be printed on a standard transaction receipt.

In accordance with an embodiment of the present invention, a system and method for automatically formatting receipt data sent to a receipt printer in a space saving format, if the data is not already in a space saving format of an embodiment of the present invention, is provided.

In accordance with an embodiment of the present invention, the use of a standard thermal receipt printer with a single thermal print head, is provided. This configuration allows for reduced price, per linear foot, of thermal paper as well as reduced purchase price of the printer itself. Additional advantages include the ease of paper loading, and power consumption—that is it fits the typical power footprint provided by most Point of Sale terminals manufactured today.

In accordance with an embodiment of the present invention, a further benefit of the current invention is its compatibility with lighter weigh thermal papers that have been offered to the market recently by paper manufacturers. These papers are thinner than standard receipt paper and consequently consume less natural resources in their manufacture.

In accordance with an embodiment of the present invention, a system and method is provided which allows for the continued support of third party advertising via pre-printed promotions and the like on the back of standard weight receipt media.

In accordance with an embodiment of the present invention, a system and method is provided for formatting a receipt such that body text can be placed side by side rather than in a vertical row. The increased efficiency of this method is expected to produce a paper savings of up to 40% over standard applications, with increased savings when used in conjunction with the lighter weight paper identified, as discussed supra.

In accordance with an embodiment of the present invention, decision criteria and formatting techniques to improve visibility of characters when an original Point of Sale application is not designed to support side by side body text format, is provided. In these instances a custom software component, either on the actual printer device, on a server, or on a lane device, is used to apply a decision criteria and formatting method to receipt data being sent to the Point of Sale printer. The net result is that a retailer can take advantage of the new format without undergoing a costly Point of Sale application upgrade, a custom printer upgrade, or subjecting themselves to the costs and limited availability of the newly introduced two sided thermal paper, as discussed supra.

In accordance with an embodiment of the present invention, a method of formatting alphanumeric characters for printing on a transaction receipt is provided. The method comprises providing a memory that is able to store data being received from a Point of Sale Software Application, providing a decision criteria whereby said data is to be manipulated in a way to reduce the total number of columns to be occupied by either blank spaces or printed characters on the transaction receipt, and providing a means of reorganizing said reduced data into a format that occupies less receipt paper than would have been occupied by the original data and format. The decision criteria of this method may comprise any combination of criteria intended to remove spaces from, truncate, or abbreviate data received from the Point of Sale application. The decision criteria of this method may comprise criteria for the reorganization of the data into a format, whereby rows of data that were intended by the Point of Sale application to be printed on a receipt row by itself is now placed on a row with other data. This method may comprise a graphical separator that is placed between two rows of data that were intended by the application to print on their own rows, but are now sharing a row on the printed receipt. Elements of the decision criteria may be set by the user in this method.

### BRIEF DESCRIPTION OF THE DRAWINGS

The present invention will be more fully understood and appreciated by reading the following Detailed Description in conjunction with the accompanying drawings, in which:

FIG. 1 is a high-level flowchart of the processing of data from a standard Point of Sale application according to an embodiment of the present invention.

FIG. 2 is a depiction of a receipt that has had the body text formatted into two equal columns according to an embodiment of the present invention.

FIG. 3 is a depiction of an example of a receipt that has had the body text formatted into unequal column sizes according to an embodiment of the present invention.

FIG. 4 is a depiction of a typical transaction receipt according to an embodiment of the present invention.

FIG. 5 is a depiction of a high-level flowchart of data being formatted within a standard Point of Sale application according to an embodiment of the present invention.

### DETAILED DESCRIPTION

In accordance with an embodiment of the present invention, a system and method for reducing the amount of paper required to print a standard transaction receipt, and, more particularly, a system and method for automatically formatting receipt data sent to a receipt printer such that body text can be placed side by side rather than in a vertical row, is provided.

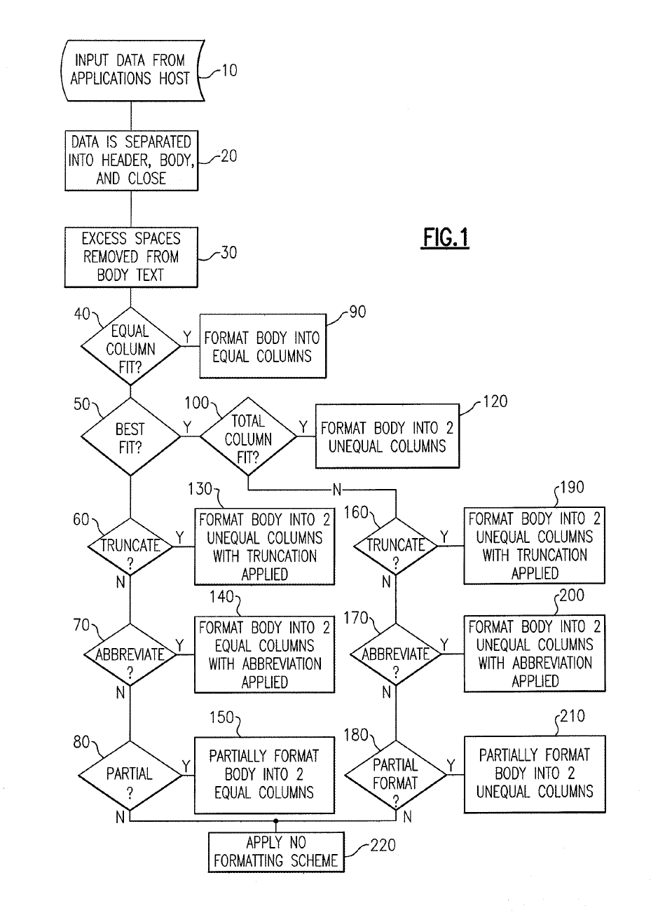

Referring now to the drawings like numbers refer to like parts throughout. Turning to FIG. 1, a high-level flowchart of the processing of data from a standard Point of Sale application according to an embodiment of the present invention is illustrated. A flowchart of the decision process that is used in an embodiment of the present invention is shown in FIG. 1, where (1) the current Point of Sale application does not support a paper saving format, and (2) a secondary piece of software is utilized to re-format the data coming from an existing host Point of Sale Application.

In accordance with an embodiment of the present invention, input data from an application host is received by a secondary piece of software in step 10. In Step 20, the software determines which portion of the received data is the Body of the receipt. In Step 30, the software removes any unnecessary spaces from a row of body text that is to be printed. Determination of what constitutes an unnecessary space may be set by either a default setting within the software or a user defined setting for maximum allowable spacing.

In accordance with an embodiment of the present invention, in step 40, a user configurable setting is analyzed to determine what the user has set for the minimum allowable font size, and it is determined if the receipt body text can now be fit into two equal columns. Step 90 is executed if the entire receipt body can be separated into multiple columns of equal width without requiring the characters to be printed at a size that is below the minimum allowable font size set by the user. In this step, the receipt header is printed as it would be in an unaltered printing operation, the body is formatted into equal columns and the closing information is printed as it would normally be printed.

In accordance with an embodiment of the present invention, Step 50 illustrates the process of determining if the customer has opted to allow the secondary software to calculate a best fit format. In this formatting process, the order of the body data is manipulated and lines of body text are paired with other lines of body text by the software in an attempt to configure a solution, whereby longer lines of body text are placed opposite shorter lines of body text. This is done in an attempt to minimize paper usage without having to undergo further means of truncation of the receipt data. This formatting process will typically result in unequal columns of data being printed. Step 100 determines if the best fit process of step 50 was able to create an acceptable receipt body that fits without violating user settings for minimum font size. If step 100 produced a favorable, “Y,” result, then the receipt body is formatted into two columns 120 where the column widths will likely, but not necessarily, be different for each row of text.

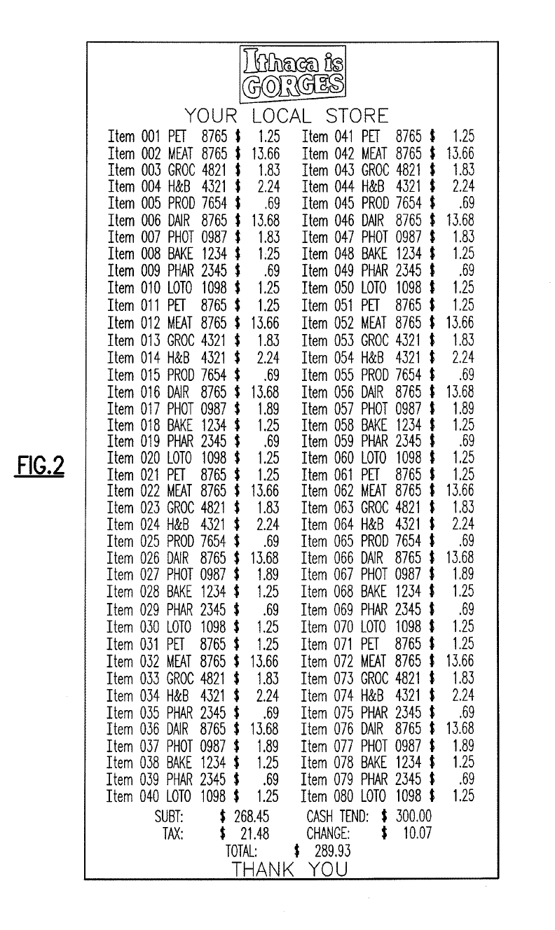

In accordance with an embodiment of the present invention, Steps 60, 70, 80, 130, 140 and 150 represent the application of several methods to further reduce the character count in any single row of body text in an effort to fully or partially format the body text into equal columns (See, e.g., FIG. 2). Application of these methods may or may not be set as allowable by the user in a software configuration setting.

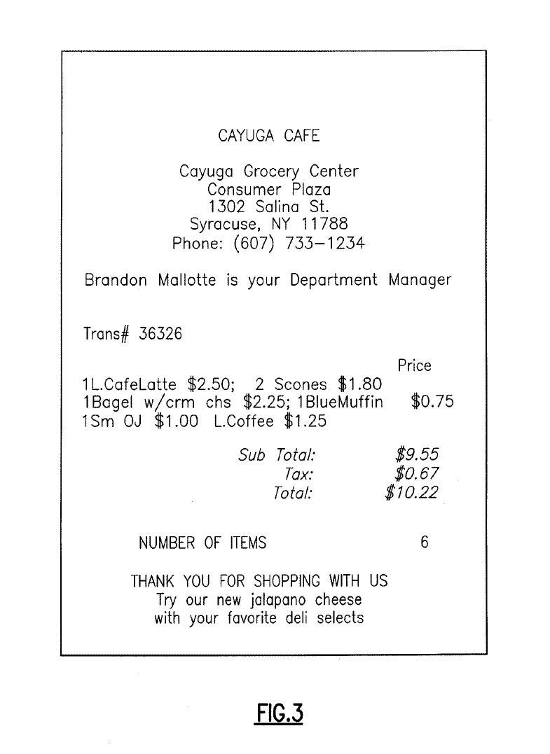

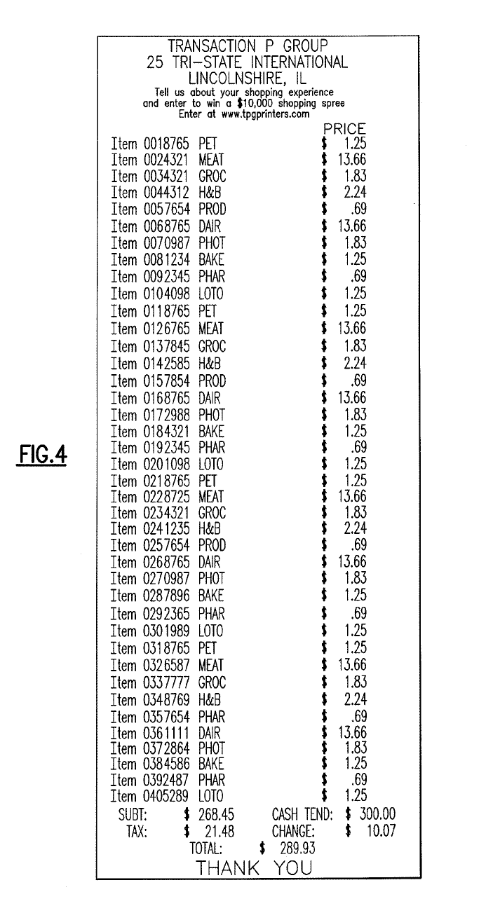

In accordance with an embodiment of the present invention, Steps 160, 170, 180, 190, 200 and 210 represent the application of several methods to further reduce the character count in any single row of body text in an effort to fully or partially format the body text into two unequal columns (See, e.g., FIG. 3). Step 220 represents the inability of the host point of sale application to print the receipt body in a multiple column format without violating any user defined constraints, and the continuation with the printing of the receipt in the standard single column format such as seen in FIG. 4.

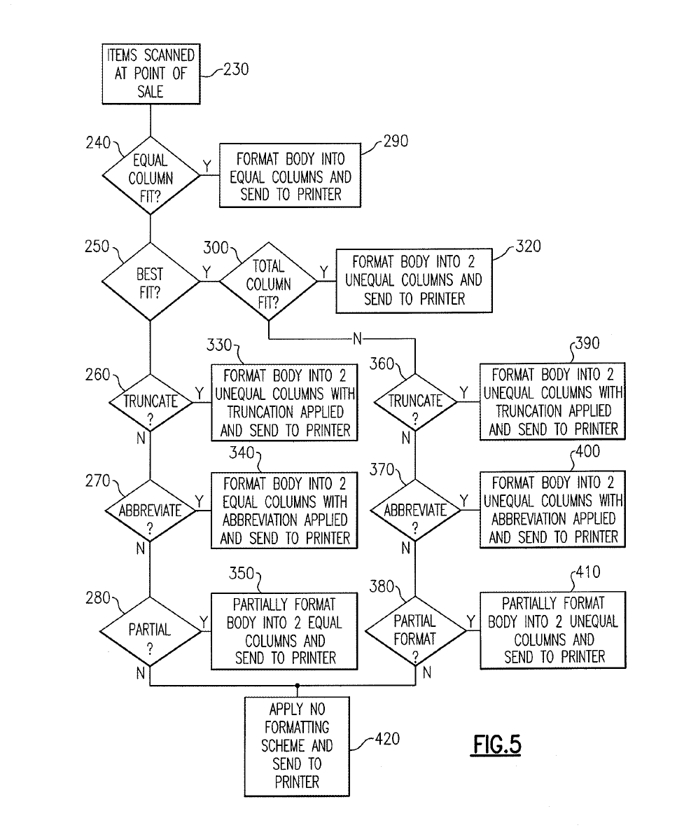

Turning to FIG. 5, a depiction of a high-level flowchart of data being formatted within a standard Point of Sale application according to an embodiment of the present invention is illustrated. A flowchart of the decision process that is used in an embodiment of the present invention, where the Point of Sale application does support a paper saving format that allows for the body of a transaction receipt to be printed in a multiple column format, is shown.

In accordance with an embodiment of the present invention, items are scanned at a typical point of sale location at step 230. In step 240, user configurable settings are analyzed to determine what the user has set for the minimum allowable font size, the item descriptions, and the total information to be printed in relation with each scanned item. In step 240, it is also determined if the receipt body text can be fit into multiple equal width columns. Step 290 is executed if the entire receipt body can be separated into equal columns without requiring the characters to be printed at a size that is below the allowable size set by the user. In this step, the receipt header is printed as it would be in an unaltered printing operation, the body is formatted into multiple columns of equal width and the closing information is printed as it would normally be printed.

In accordance with an embodiment of the present invention, step 250 includes the process of determining if the customer has opted to allow the point of sale software to calculate a best fit format. In this formatting process, the order of the body data is manipulated, and lines of body text are paired with other lines of body text by the software in an attempt to configure a solution, whereby longer lines of body text are placed opposite shorter lines of body text. This is done in an attempt to minimize paper usage without having to undergo further means of truncation of the receipt data. This formatting process will typically result in unequal columns of data being printed.

In accordance with an embodiment of the present invention, step 300 determines if the best fit process of step 250 was able to create an acceptable receipt body that fits without violating minimum allowable font settings. If step 300 produced a favorable, “Y”, result, then the receipt body is formatted into multiple columns 320 where the column widths will likely, but not necessarily, be different for each row of text.

In accordance with an embodiment of the present invention, steps 260, 270, 280, 330, 340 and 350 represent the application of several methods to further reduce the character count in any single row of body text in an effort to fully or partially format the body text into equal columns (See, e.g., FIG. 2). Application of these methods may or may not be set as allowable by the user in a software configuration setting.

In accordance with an embodiment of the present invention, steps 360, 370, 380, 390, 400 and 410 represent the application of several methods to further reduce the character count in any single row of body text in an effort to fully or partially format the body text into unequal columns (See, e.g., FIG. 3). Step 420 represents the inability of the host point of sale application to print the receipt body in a multiple column format without violating any user defined constraints, and the continuation with the printing of the receipt in the standard single column format such as seen in FIG. 4.

What is claimed is:

1. A method for formatting receipt data that is representative of text to be printed on a receipt printer wherein at least certain of the data will be printed in at least two columns each of predetermined lengths, comprising the steps of:
a. categorizing the receipt data in one of a header section, body section, or close section;
b. applying a predetermined rule for removing a predetermined amount of spaces from the receipt data that has been categorized into said body section;
c. applying a predetermined criteria to said receipt data that has been categorized into said body section and determining whether it can be fit into two equal columns; and
d. sending an instruction to print the receipt.

2. The method for formatting receipt data according to claim 1, further comprising the step of configuring the text represented in the receipt data that has been categorized into said body section into at least two columns based upon analysis of the amount of data present in each piece of receipt data that has been categorized into said body section.

3. The method for formatting receipt data according to claim 2, wherein the text configured to appear in each of said at least two columns are of unequal lengths.

4. The method for formatting receipt data according to claim 1, further comprising the step of adjusting the receipt data that has been categorized into said body section such that the text represented thereby will be printed in at least two columns of equal length.

5. The method for formatting receipt data according to claim 4, wherein the length adjusting step comprises truncating the text represented by the receipt data in order to create at least two columns each of equal length.

6. The method for formatting receipt data according to claim 4, wherein the length adjusting step comprises applying abbreviations to the text represented by the receipt data in order to create at least two columns each of equal length.

7. A computer readable product stored on a computer readable medium for formatting receipt data that is representative of text to be printed on a receipt printer wherein at least certain of the text will be printed in at least two columns each of predetermined lengths, comprising:
a. means for categorizing the receipt data in one of a header section, body section, or close section;
b. means for applying a predetermined rule for removing a predetermined amount of spaces from the receipt data that has been categorized into said body section;
c. means for applying a predetermined criteria to said receipt data that has been categorized into said body section and determining whether it can be fit into two equal columns; and
d. means for printing the receipt.

8. The computer readable product for formatting receipt data according to claim 7, further comprising means for configuring the text represented in the receipt data that has been categorized into said body section into at least two columns based upon analysis of the amount of data present in each piece of receipt data that has been categorized into said body section.

9. The computer readable product for formatting receipt data according to claim 8, wherein the text configured to appear in each of said at least two columns are of unequal lengths.

10. The computer readable product for formatting receipt data according to claim 7, further comprising means for adjusting the receipt data that has been categorized into said body section such that the text represented thereby will be printed in at least two columns of equal length.

11. The computer readable product for formatting receipt data according to claim 10, wherein the means for length adjusting comprises means for truncating the text represented by the receipt data in order to create at least two columns each of equal length.

12. The computer readable product for formatting receipt data according to claim 10, wherein the means for length adjusting step comprises means for applying abbreviations to the text represented by the receipt data in order to create at least two columns each of equal length.
